(19) United States
(12) Patent Application Publication
(10) Pub. No.: US 2026/0202550 A1
(43) Pub. Date: Jul. 16, 2026

(54) SYSTEM AND METHOD OF DETERMINING A GEOGRAPHICAL LOCATION OF ONE OR MORE COMPUTING DEVICES

(71) Applicant: Eye-Net Mobile Ltd., Ness Ziona (IL)

(72) Inventors: Dror ELBAZ, Rishon Lezion (IL); Tal LAVI, Modi’in (IL)

(73) Assignee: Eye-Net Mobile Ltd., Ness Ziona (IL)

(21) Appl. No.: 18/869,456

(22) PCT Filed: May 24, 2023
(86) PCT No.: PCT/IL2023/050538

§ 371 Date: Nov. 26, 2024

Related U.S. Application Data
(60) Provisional application No. 63/345,964, filed on May 26, 2022.

(51) Int. Cl. G01S 19/24; B60W 60/00; G01S 19/51

(52) U.S. Cl. CPC G01S 19/24; B60W 60/00; G01S 19/51

(57) ABSTRACT

A system and method for determining a geographical location of one or more computing devices may include coupling a first computing device with one or more second computing devices, obtaining two or more position data elements representing geographical locations of the computing devices, and calculating a refined position data element of the first computing device based on the received position data elements. The system may include a non-transitory memory device, where modules of instruction code are stored, and at least one processor associated with the memory device, configured to execute the modules of instruction code. The method may include associating the at least one processor with a vehicle module of a vehicle and sending the refined position data element to the vehicle module, where the vehicle module may be configured to, for example, control a steering system of the vehicle.

### CROSS REFERENCE TO RELATED APPLICATIONS

This application claims the benefit of priority of U.S. Provisional Patent Application No. 63/345,964, filed 26 May 2022, which is hereby incorporated by reference in its entirety.

### FIELD OF THE INVENTION

The present invention relates generally to geographical location technology. More specifically, the present invention relates to methods of determining a geographical location of a computing device.

### BACKGROUND OF THE INVENTION

Determining geographical location is commonly performed by computing devices based on Global Positioning System (GPS) technology. Such determined geographical location may be used for various purposes, such as in portable navigation devices, in planning convenient routes for private or public transportation, for various industrial uses such as architecture and construction design, for military uses, for navigation uses, and unmanned aerial vehicles (UAV) flight control.

Additional means by which geographical location can be calculated include utilization of cellular communication to calculate geographical location of a cellular device.

The accuracy of the calculated geographical location is of great importance in many applications, especially in systems where safety is at stake. However, different devices, different calculation methods, or even different components on the same device, may obtain different levels of accuracy of location calculation. For example, two cellular phones that are located near each other may calculate different geographical locations.

In cases where a device has a number of different means for calculating its geographical location (e.g., GPS, triangulation tower triangulation, and the like), the device's geolocation will be determined according to the most accurate means available. However, it may not always be possible to obtain a sufficiently accurate measurement of the device's geolocation. This limitation may hinder the functionality of systems that depend on calculation of precise location for their operations, and in some cases, may even stop systems from operating altogether. Therefore, there is a need for a method of revising or refining geographical location calculation results.

### SUMMARY OF THE INVENTION

Embodiments of the invention may provide a big data, software based approach of real time calibration, and/or error detection and correction of location measurements in mobile computing devices such as mobile phones.

Currently available high-end, hardware-based systems may provide accurate location measurements. Such measurements are typically not available for commonly used mobile or cellular devices. For example, differential GPS (DGPS) devices may employ Radio Frequency (RF) technology and base stations, in addition to signals received from satellites, to produce exceptional location accuracy, in the scale of approximately 2 cm. Causes for GPS errors may be roughly categorized into two categories.

The first category may be referred to as global errors, which are not specific to a specific device and may uniformly affect many devices at once. Most notably in this category are (a) slight errors in the satellite's location (e.g., a satellite may “think” it's in a set location, but the actual location may be different) and (b) disturbances in the ionosphere which may cause the RF signal to break/delay slightly. A second category of errors may be referred to as localized errors, which may be caused by not having a direct path to the satellite (e.g., due to unclear sky or reflection from obstacles).

Experimental results have shown that all GPS devices may be prone to localized errors in some degree, but the global errors may affect different devices differently, probably due to different generation of GPS chips, or by having different chips attuned to different satellite constellations.

Embodiments of the invention may target the global errors, to improve calibration of location measurements for mobile computing devices.

Embodiments of the invention may accumulate location measurements (e.g., GPS based location measurements) from a plurality of users in a database, and find candidate locations suitable to be used as calibration points or reference points, as elaborated herein. This may include searching the database for locations where the bearing of users passing through a point is relatively uniform, and the sideways offset of positions around the point may also be relatively uniform. Embodiments of the invention may obtain ground truth measurements of the calibration points, e.g., by using ultra-accurate DGPS to measure the actual coordinates of the reference points and construct a database consisting of these calibration points.

When a device of interest passes through (e.g., within a predefined vicinity of) a calibration point, embodiments of the invention may measure a minimal distance offset of that computing device, in relation to that calibration (reference) point, at that time. Embodiments of the invention may then use this information to fix raw, location (e.g., GPS) measurement data, to provide a calibrated location measurement, as elaborated herein.

Embodiments of the invention may employ combinations of calibration vectors, from a respective plurality of reference points to produce a complete, dynamic (e.g., updated over time) calibration profile for one or more (e.g., each) served client computing device. For example, Embodiments of the invention may utilize a calibration point where the user is heading north to fix an east-west offset, and utilize another reference point where the user is heading east, to fix a north-south offset.

Embodiments of the invention may utilize this calibration for a plurality of location measurements, pertaining to a cluster comprising a respective plurality of client devices. Embodiments may thus determine which measurements within the cluster should be attributed a maximal weight, to determine a location of the member computing devices.

Embodiments of the invention may identify additional calibration (reference) points without requiring ground truth location measurements (e.g., via DGPS) for these points. For example, embodiments of the invention may: (i) locate the most accurate devices which best matches the ground truth. (ii) Find additional candidate points, having uniform bearing and offset values and (iii) use the data from the most accurate devices as the ground truth, and fix the rest of the devices according to them.

Embodiments of the invention may provide the calibration of location measurement for client computing devices as a service to third-party companies interested in improving their location (e.g., GPS) accuracy. In such embodiments, a calibration service may be proposed where a client device sends a stream of GPS points, and the service continuously responds with a stream of calibration vectors for correcting offset of the client computing device in relation to reference points. Such a service may present an improvement over currently-available calibration services, which (a) require raw GNSS GPS message information, that may not be available on all mobile devices (e.g. iOS devices), and (b) may require raw data received from each satellite, and (c) requires costly installations of base stations.

Embodiments of the invention may receive a plurality of location data elements, representing geographical locations of a respective plurality of devices that are located near each other (e.g., located in a same vehicle), and obtain a refined version of the location data elements, representing a refined geographical location of the plurality of devices.

Some embodiments of the present invention are directed to a method of determining a geographical location of a first computing device by at least one processor. Embodiments of the method may include: coupling the first computing device with one or more second computing devices; obtaining at least one first position data element, representing a geographical location of the first computing device; receiving, from at least one second computing device of the one or more second computing devices a second position data element, representing a geographical location of the at least one second computing device; and calculating a first refined position data element representing a determined location of the first computing device, based on the first position data element and the at least one second position data element.

In some embodiments, the first position data element may include a first confidence value, representing a reliability of the geographical location of the first computing device. In some embodiments, the at least one second position data element may include at least one respective second confidence value, representing a reliability of the geographical location of the at least one second computing device. In some embodiments, calculating the refined position data element may be further based on the first confidence value and the at least one second confidence value.

In some embodiments, the first position data element may include a first timestamp, corresponding to the geographical location of the first computing device, where the at least one second position data element may include at least one respective second timestamp, corresponding to the geographical location of the at least one second computing device. In some embodiments, calculating the refined position data element may be based on the first timestamp and the at least one second timestamp. For example, a calculation of the refined position data element may include computing a weighted average of the first position data element and the at least one second position data element, which may include a weighted representation of the corresponding timestamps.

In some embodiments, the first computing device may include at least one processor that may be associated with, or communicatively connected to a controller of a vehicle module that is included in a vehicle. The first computing device may transmit the refined position data element to the vehicle module.

The vehicle module may utilize the refined position data element to perform, for example: controlling a steering system of the vehicle, controlling a braking system of the vehicle, controlling an accelerator of the vehicle, and producing a collision warning on a user interface of the vehicle.

In some embodiments, the method of determining a geographical location of a first computing device may include: sending the refined position data element to at least one second computing device of the one or more second computing devices; and using the refined position data element as representing the geographical location of the at least one second computing device.

In some embodiments, the at least one second computing device of the one or more second computing devices may be associated with a vehicle module of a vehicle. In such embodiments, the vehicle module may be configured to utilize the refined position data element to perform at least one of: controlling a steering system of the vehicle; controlling a braking system of the vehicle; controlling an accelerator of the vehicle; producing a collision warning on a user interface of the vehicle; and any combination thereof.

In some embodiments, coupling the first computing device with a second computing device may include: receiving, via a first user interface (UI) of the first computing device a coupling request; sending a coupling request message to the second computing device, based on the request; receiving a coupling approval message from the second computing device; and coupling the first client computing device with the second client computing device based on the approval message.

In some embodiments, coupling the first computing device with at least one second computing device may include: using a first short range communication device (SRD) associated with the first computing device to detect at least one second SRD associated with the at least one second computing device; sending a coupling request message via the first SRD to the at least one second SRD; receiving a coupling approval message from the at least one second computing device via the first SRD; and coupling the first computing device with the at least one second computing device via the first SRD.

In some embodiments, the first SRD may be selected from a list consisting of: a Wi-Fi device, a Bluetooth device, and a Near Field Communication (NFC) device.

In some embodiments, the first computing device may be chosen as a primary device, where the primary device provides a majority of computing power to determine the geographical location of the first computing device.

In some embodiments, the at least one processor may pertain to a server computing device, where the first computing device and the one or more second computing devices may be client computing devices, communicatively connected to the server computing device.

Some embodiments of the present invention are directed to a method of determining, by at least one processor of a server computing device, a geographical location of one or more client computing devices. In some embodiments, the method may include: receiving at least one grouping data element, representing a cluster of one or more client computing devices; obtaining, from at least one client computing device of the one or more client computing devices, at least one respective position data element, representing a geographical location of at least one client computing device; and calculating a refined position data element representing a determined location of the cluster of one or more client computing devices, based on at least one of: one or more position data elements, and one or more grouping data elements.

In some embodiments, the at least one processor of the server may be configured to send the refined position data element to a vehicle module, associated with a vehicle, where the vehicle module is configured to utilize the refined position data element to perform at least one of: controlling a steering system of the vehicle; controlling a braking system of the vehicle; controlling an accelerator of the vehicle; and producing a collision warning on a user interface of the vehicle.

Some embodiments of the present invention are directed to a system for determining a geographical location of one or more client computing devices. In some embodiments, the system may include: a non-transitory memory device, where modules of instruction code are stored, and at least one processor associated with the memory device, and configured to execute the modules of instruction code, whereupon execution of the modules of instruction code, the at least one processor is configured to: receive a grouping data element, representing a cluster of one or more client computing devices; obtain, from at least one client computing device of the one or more client computing devices, at least one respective position data element, representing a geographical location of at least one client computing device; and calculate a refined position data element representing a determined location of the cluster of one or more client computing devices, based on at least one of the one or more position data elements and the one or more grouping data elements.

Embodiments of the invention may include a system for determining a geographical location. Embodiments of the system may include a server computing device configured to: obtain one or more reference points, each representing a geographical location, and attributed ground-truth longitude and latitude values. The server computing device may receive, from at least one client computing device, at least two position data elements, each including measured longitude and latitude values of the client computing device. Based on the position data elements, the server computing device may determine a direction of motion of the client computing device, and calculate a minimal traversal distance between the client computing device and a geographical location of a specific reference point. Based on the minimal traversal distance, the server computing device may produce a reference-specific calibration vector, pertaining to the specific reference point. The reference-specific calibration vector may represent a required correction of location of the at least one client computing device in a direction substantially perpendicular to the direction of motion.

According to some embodiments, the server computing device may transmit the reference-specific calibration vector to the client computing device. The at least one client computing device may be configured to receive an instant position data element that may include measured values of longitude and latitude of the client computing device. The at least one client computing device may subsequently apply the reference-specific calibration vector on the instant position data element, to obtain a calibrated position data element, representing a corrected geographical location of the client computing device.

Additionally, or alternatively, the server computing device may be configured to produce a plurality of reference-specific calibration vectors, each pertaining to a respective, unique reference point. The at least one client computing device may be configured to calculate an aggregate calibration vector based on the plurality of reference-specific calibration vectors; and apply the aggregate calibration vector on the instant position data element, to obtain the calibrated position data element.

According to some embodiments, one or more (e.g., each) reference-specific calibration vectors may be attributed a traversal timestamp, representing a time at which the client computing device was at the minimal traversal distance from the geographical location of the respective reference point. In such embodiments, the client computing device may be configured to calculate the aggregate calibration vector further based on the traversal timestamps, as elaborated herein.

According to some embodiments the server computing device may obtain a reference point by selecting reference points from a plurality of geodata points. For example, the server computing device may receive a dataset that may include a plurality of geodata points, each representing a respective geographical location, and representing ground-truth longitude and latitude values. For one or more (e.g., all) geodata points. The server computing device may, calculate a direction uniformity value based on the position data elements, which represents a level of uniformity of direction of motion of client computing devices within a predetermined vicinity of the respective geographical location. The server computing device may then select the reference points among the plurality of geodata points, based on the direction uniformity values (e.g., select reference points having maximal direction uniformity values).

Additionally, or alternatively, the server computing device may: for one or more geodata points, calculate a distance uniformity value based on the position data elements, wherein the distance uniformity value represents a level of uniformity of minimal traversal distances between client computing devices and the geodata point; and select the reference point among the plurality of geodata points, further based on the distance uniformity values (e.g., select reference points having maximal distance uniformity values), and/or any combination thereof.

According to some embodiments, the at least one client computing device may include a first client computing device, and one or more second client computing devices. The first client computing device may be configured to couple with the one or more second client computing devices; obtain a calibrated position data element, representing a corrected geographical location of the first client computing device; and receive, from at least one second computing device of the one or more second computing devices a second calibrated position data element, representing a corrected geographical location of the at least one second computing device. The first client computing device may subsequently calculate a first refined position data element representing a refined location of the first computing device, based on the first calibrated position data element and the at least one second calibrated position data element.

According to some embodiments, the first calibrated position data element may include a first confidence value, representing a reliability of the corrected geographical location of the first client computing device, and wherein the at least one second calibrated position data element may include at least one respective second confidence value, representing a reliability of the geographical location of the at least one second computing device. The first client computing device may be configured to calculate the first refined position data element further based on the first confidence value and the at least one second confidence value, as elaborated herein.

Additionally, or alternatively, the first calibrated position data element may include, or be associated with a first timestamp, corresponding to the geographical location of the first computing device. The at least one second calibrated position data element may include, or be associated with at least one respective second timestamp, corresponding to the geographical location of the at least one second computing device. The first client computing device may be configured to calculate the refined position data element further based on the first timestamp and the at least one second timestamp, as elaborated herein.

Additionally, or alternatively, the first calibrated position data element may be associated with a first minimal traversal distance value, and the at least one second calibrated position data element may be associated with at least one respective second minimal traversal distance value. The first client computing device may calculate the refined position data element further based on the first minimal traversal distance value and the at least one second minimal traversal distance value, as elaborated herein.

According to some embodiments, the first computing device may be configured to transmit the refined position data element to at least one controller of a vehicle module of a vehicle. The vehicle module may be configured to utilize the refined position data element to perform at least one action selected from: controlling a steering system of the vehicle; controlling a braking system of the vehicle; controlling an accelerator of the vehicle; producing a collision warning on a user interface of the vehicle; and any combination thereof.

According to some embodiments, the first computing device may transmit the refined position data element to at least one second computing device of the one or more second computing devices. The at least one second computing device may subsequently use the refined position data element to represent its geographical location.

Additionally, or alternatively, the at least one second computing device of the one or more second computing devices may be associated with a vehicle module of a vehicle. The vehicle module may be configured to utilize the refined position data element to perform at least one action of: controlling a steering system of the vehicle; controlling a braking system of the vehicle; controlling an accelerator of the vehicle; producing a collision warning on a user interface of the vehicle; and any combination thereof.

According to some embodiments, the first client computing device may be configured to couple with the one or more second client computing devices by: receiving, via a user interface (UI) of the first computing device a coupling request; sending a coupling request message to the second computing device, based on said coupling request; receiving a coupling approval message from the second computing device; and coupling with the second client computing device based on said approval message.

Additionally, or alternatively, the first client computing device may be configured to couple with the one or more second client computing devices by: using a first short range communication device (SRD) associated with the first computing device to detect at least one second SRD associated with the at least one second computing device.

the first SRD device and/or second SRD device may, for example be a Wi-Fi device, a Bluetooth device, a Near Field Communication (NFC) device, and the like. The first client computing device may send a coupling request message via the first SRD to the at least one second SRD, and receive a coupling approval message from the at least one second computing device via the first SRD. The first client computing device may subsequently couple with the at least one second computing device via the first SRD.

According to some embodiments, the first client computing device and the at least one second client computing devices may be configured to negotiate a role of a primary client computing device, based on the first confidence value and the at least one second confidence value. The primary device may be configured, for example, to provide a majority of computing power to determine the refined geographical locations of the first client computing device and the at least one second client computing device.

According to some embodiments, the first client computing device may repeat calculation of the first refined position data element in a plurality of iterations, to obtain a respective plurality of (i) first refined position data elements, and (ii) corresponding confidence values, representing reliability of the refined geographical location of the first computing device in that iteration. The first client computing device may subsequently calculate a summary refined position data element representing a determined location of the first computing device, based on the plurality of first position data elements, and the respective plurality of confidence values.

According to some embodiments, the plurality of first refined position data elements may include a timestamp, corresponding to the geographical location of the first computing device in that iteration. The first client computing device may be configured to calculate the summary refined position data element further based on the plurality of timestamps, as elaborated herein.

Embodiments of the invention may include a method of determining a geographical location of a client computing device by at least one processor. Embodiments of the method may include, for example receiving, from at least one client computing device, at least two position data elements, each may include measured longitude and latitude values of the client computing device; based on the position data elements, determining a direction of motion of the client computing device; based on the position data elements, calculating a minimal traversal distance between the client computing device and a reference point, wherein the reference point may be attributed ground-truth longitude and latitude values; based on the minimal traversal distance, producing a reference-specific calibration vector, pertaining to the reference point, and representing a required correction of location in a direction substantially perpendicular to the direction of motion; and applying the reference-specific calibration vector on an instant position data element, to obtain a calibration position data element, representing corrected geographical location of the client computing device.

According to some embodiments, the at least one processor may apply the reference-specific calibration vector by transmitting a plurality of reference-specific calibration vectors, each pertaining to a unique reference point, to the client computing device. The client computing device may be configured to: calculate an aggregate calibration vector based on the plurality of reference-specific calibration vectors; and apply the aggregate calibration vector on measured values of longitude and latitude of the instant position data element, to obtain a calibrated position data element, that may include, or represent corrected values of longitude and latitude.

Embodiments of the invention may include a method of determining, by at least one processor of a server computing device, a geographical location of one or more client computing devices. Embodiments of the method may include: receiving at least one grouping data element, representing a cluster of one or more client computing devices; obtaining, from at least one client computing device of the one or more client computing devices, at least one respective position data element, representing a geographical location of at least one client computing device; and calculating a refined position data element representing a determined location of the cluster of one or more client computing devices, based on at least one of: one or more position data elements, and one or more grouping data elements.

Additionally, or alternatively, the at least one processor of the server may be configured to send the refined position data element to a vehicle module, associated with a vehicle. The vehicle module may be configured to utilize the refined position data element to perform at least one of: controlling a steering system of the vehicle; controlling a braking system of the vehicle; controlling an accelerator of the vehicle; and producing a collision warning on a user interface of the vehicle.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for determining a geographical location of one or more computing devices, according to some embodiments;

FIGS. 2A and 2B are block diagrams, depicting a system for determining a geographical location of one or more computing devices, according to some embodiments;

FIG. 3 is a block diagram, depicting a system for determining a geographical location of one or more computing devices, according to some embodiments;

FIG. 4 is a block diagram, depicting modules of a system for determining a geographical location of one or more computing devices according to some embodiments;

FIG. 5 is a block diagram, depicting a server system for determining a geographical location of one or more computing devices according to some embodiments;

FIG. 6 is a flow diagram of a method of determining a geographical location of one or more computing devices according to some embodiments of the invention;

FIG. 7 is a block diagram depicting modules of a system for determining a geographical location of one or more computing devices, according to some embodiments of the invention;

FIGS. 8A1, 8A2, 8B1, 8B2, 8C1, 8C2 and 8C3 are schematic graphs, illustrating criteria for selection of geodata points according to predefined criteria, to obtain therefrom one or more reference points, according to some embodiments of the invention;

FIG. 9 is a flowchart of a method of determining a geographical location of a client computing device, by at least one processor, according to some embodiments of the invention; and

FIG. 10 is a flowchart of a method of determining, by at least one processor of a server computing device, a geographical location of one or more client computing devices, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to particular order or sequence. Additionally, some of the described method embodiments or elements thereof can occur or be performed simultaneously, at the same point in time, or concurrently.

The following Table 1 may be used as a reference to terminology used herein, for the reader's convenience.

TABLE 1

| | |
|---|---|
| “Coupling” | The term “coupling” may be used herein to refer to operations |
| | and/or processes of a first computing device, to |
| | communicatively connect to one or more second computing |
| | device, for the purpose of transferring data. |
| Position data element | A position data element may represent a geographic location of |
| | a respective client (or computing device). Position data |
| | elements may include one or more attributes such as |
| | timestamps and/or confidence values, corresponding to the |
| | respective position data element. |
| Geographic location | A geographic location module may be configured to provide a |
| module | position data element to one or more respective computing |
| | devices. For example, a geographic location modules may be, or |
| | may include a Global Positioning System (GPS) receiver |
| | configured to calculate a position data element based on a GPS |
| | system. In another example, a geographic location module may |
| | be, or may include a mobile device configured to determine a |
| | position data element based on triangulation information from |
| | base stations of the mobile device's carrier network. |
| Analysis module | An analysis module may be configured to receive two or more |
| | position data elements from respective geographic location |
| | modules, and determine a refined position data element |
| | representing a location of one or more respective computing |
| | devices. Additionally, or alternatively, an analysis module may |
| | be configured to calculate a refined position data element of a |
| | respective computing device based on at least one attribute |
| | corresponding to the received position data elements. |
| Refined position data | A refined position data element may represent a geographic |
| element | location of one or more computing devices. Refined position |
| | data elements may be calculated, e.g., via an analysis module, |
| | based on two or more position data elements. The term |
| | “refined” may be used in this context of a “refined position data |
| | element” to indicate an improvement (e.g., an improvement of |
| | accuracy) with respect to a representation of geographic |
| | location. Refined position data elements may be an |
| | improvement over currently available systems that only rely on |
| | receiving a single position data elements (e.g., from a |
| | geographic location module). |
| Vehicle module | The term “vehicle module” may be used herein to refer to a |
| | software and/or hardware element, that may be associated with |
| | a vehicle, and may utilize a refined position data element |
| | according to a specific configuration. |
| | For example, a vehicle module may include, or may be |
| | associated with a controller of an autonomous vehicle, |
| | configured to control a steering system of said vehicle, control a |
| | braking system of said vehicle, control an accelerator of said |
| | vehicle, and the like. |
| | In another example, a vehicle module may be associated with a |
| | processor of an advanced driver-assistance system (ADAS) of a |
| | vehicle, configured to produce, for example, a collision warning |
| | on a user interface associated with said vehicle. |
| | Vehicle modules may be, or may include: an ADAS, an |
| | autonomous vehicle controller, an adaptive cruise control |
| | system, a pedestrian warning system, and a parking assist |
| | system. |

Embodiments of the present invention may include a method and a system for determining a geographical location of a computing device. In some embodiments, a determination of a computing device's location may be achieved by comparing said computing device's location to at least one additional computing device's location. Additionally, or alternatively, a determination of a computing device's location may be performed by a server associated with the computing device. Additionally, or alternatively, a determination of a computing device's location may be performed by at least one processor associated with the computing device.

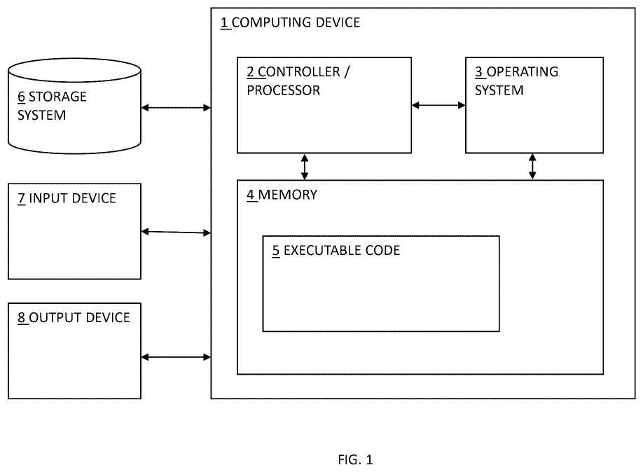

Reference is now made to FIG. 1, which is a block diagram depicting a computing device, which may be included within an embodiment of a system for determining a geographical location of one or more computing devices, according to some embodiments of the invention.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may include instructions for determining a geographical location of one or more computing devices, as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data, which may include position data elements, confidence values, or timestamps as further described herein, may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

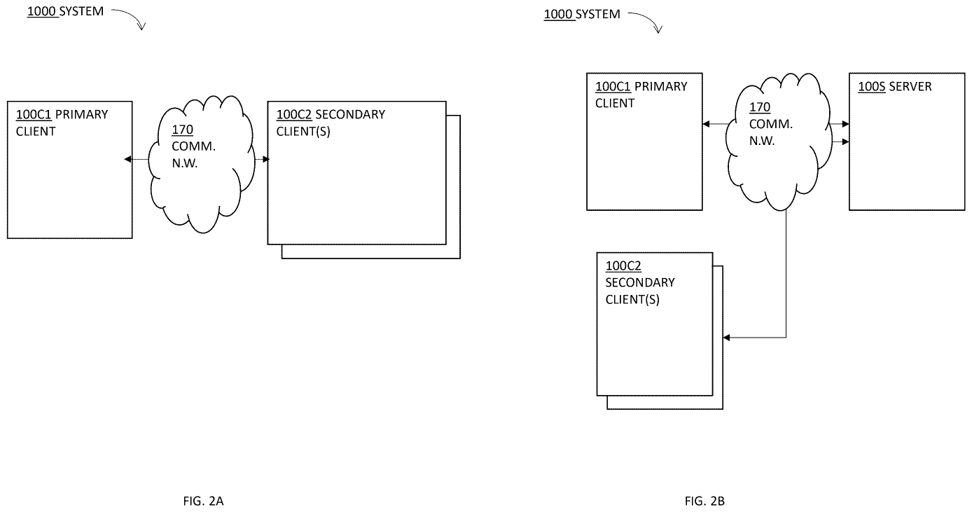

Reference is now made to FIGS. 2A and 2B, which depict examples for configurations of a system for determining a geographical location of one or more computing devices, according to some embodiments of the invention.

In one example, as illustrated in FIG. 2A, system 1000 may include a primary computing device, also referred to herein as a primary client 100C1, and at least one secondary computing device, also referred to herein as a secondary client 100C2. According to some embodiments, clients 100C1 and/or 100C2 may be, or may include a computing device such as computing device 1 of FIG. 1. In some embodiments, clients 100C1 and/or 100C2 may be, or may include a mobile computing device such as a mobile phone, or a smartphone, which may include, or may be associated with a global positioning device, as elaborated herein.

Primary client 100C1 and the and the at least one secondary client 100C2 may be communicatively connected, e.g., via a communication network 170 such as Bluetooth, Near Field Communication (NFC), Internet Protocol, and/or a cellular data network. According to some embodiments, primary client 100C1 and the at least one secondary client 100C2 may be adapted to communicate location-related information, via communication network 170.

Primary client 100C1 may subsequently determine a geographic location data element, representing a geographic location of primary client 100C1, based on location-related information received from the one or more secondary clients 100C2, as elaborated herein.

The terms “primary” and “secondary” may be used herein to indicate a relation between a first computing device 100 and a second device 100. For example, a primary computing device 100C1, or primary client 100C1 may be a primary source of location data to be used, e.g., to improve or enhance location accuracy for all devices (e.g., including secondary computing devices 100C2). Additionally, or alternatively, a primary computing device 100C1, or primary client 100C1 may be a referred to as “primary” in a sense that it may perform the required geo-location calculations, so as to conserve computing resources (e.g., power, computation cycles, memory, etc.) for all computing devices (e.g., including secondary computing devices 100C2).

In some embodiments, a client computing device 100 (e.g., 100C1, 100C2) is chosen as a “primary device” 100C1 (also referred to herein as “primary client” 100C1) which may occur at any phase or step of the method of determining a geographical location of one or more client computing devices 100.

For example, primary device 100C1 may provide a majority of computing power, from said primary device 100C1, to execute instructions of determining a geographical location as described herein. In other words, primary device 100C1 may calculate a geographic location data element (also referred to herein as “refined position data element 110RL”), representing a geographic location of primary client 100C1, based on location-related information received from the plurality of clients 100C1 and 100C2, as elaborated herein.

Additionally, or alternatively, primary device 100C1 may provide a majority of network bandwidth, from said primary device 100C1, to execute instructions for calculating refined position data element 110RL, and determining the geographical location of clients 100C1 and 100C2, as described herein.

In some embodiments, primary device 100C1 may be selected from the one or more client computing devices 100 based on inherent attributes of client computing devices 100. In some embodiments, non-limiting examples of inherent attributes of client computing devices 100 include: available computing resources, a global positioning system (GPS) location confidence value pertaining to said computing device's GPS, and an operating system version.

Additionally, or alternatively, additional primary device 100C1 may be selected from the one or more client computing devices 100. In such embodiments, the two or more primary client devices 100C1 may collaborate to determine their respective geographical locations, as described herein.

In another example, as illustrated in FIG. 2B, system 1000 may be a server-client system that includes at least one server 100S, adapted to communicate location-related information to and/or from a plurality of clients 100C1 and 100C2. In such embodiments, server 100S may calculate refined position data element 110RL, based on location-related information received from the plurality of clients 100C1 and 100C2, as elaborated herein.

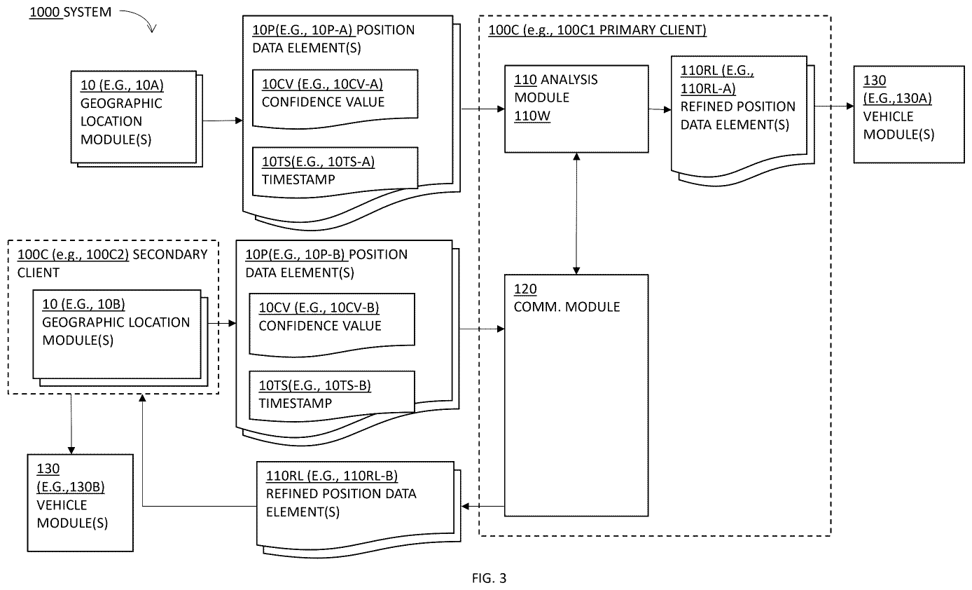

Reference is now made to FIG. 3, which depicts modules of a system 1000 for determining a geographical location of one or more computing devices, according to some embodiments of the invention. System 1000 of FIG. 3 may be the same as system 1000 of FIG. 2A and/or FIG. 2B.

As shown in FIG. 3, arrows may represent flow of one or more data elements to and/or from system 1000 and/or among modules or elements of system 1000, according to some aspects of the invention discussed herein. Some arrows have been omitted in FIG. 3 for the purpose of clarity.

As depicted in the example of FIG. 3, one or more computing devices 100 (e.g., primary client 100C1), may be associated with, or communicatively connected to a respective geographic location module (e.g., geographic location module 10). Additionally, or alternatively, one or more computing devices (e.g., secondary clients 100C2) may have, or may include a respective geographic location module (e.g., geographic location module 10B).

According to some embodiments, geographic location module 10 (e.g., 10A, 10B) may be configured to provide, to the one or more respective computing devices 100 (e.g., 100C1, 100C2) a position data element 10P (e.g., a primary position data element 10P-A or secondary position data element 10P-B, as also referred to herein). Position data element 10P may, for example, include longitude and latitude coordinates, representing a geographic location of the respective client (e.g., 100C1, 100C2).

For example, geographic location module 10 (e.g., 10A, 10B) may be, or may include a Global Positioning System (GPS) receiver configured to calculate a position data element 10P based on a GPS system, as known in the art. In another example, geographic location module 10 may be, or may include a mobile device configured to determine position data element 10P based on triangulation information from base stations of the mobile device's carrier network.

Position data element 10P (e.g., 10P-A, 10P-B) may include at least one attribute. Non-limiting examples of attributes of the position data element 10P include: a confidence value 10CV (e.g., 10CV-A, 10CV-B) and a timestamp 10TS value (e.g., 10TS-A, 10TS-B).

Confidence value 10CV (e.g., 10CV-A, 10CV-B) may indicate accuracy or reliability of position data elements as representing a real-world geographical location of a respective client 100 (e.g., 100C1, 100C2).

For example, geographical location module 10 (e.g., 10A, 10B) may receive (e.g., GPS positioning data 10P alongside confidence value 10CV. In such embodiments, confidence value 10CV may represent accuracy (e.g., measured in meters) and may represent a distance (e.g., measured in meters) from ground-truth geolocation in a predefined probability (e.g., 67%).

Timestamp 10TS (e.g., 10TS-A, 10TS-B) may represent a point in time in which the measurement of geographical location, e.g., position data element 10P (e.g., 10P-A, 10P-B), was obtained or performed. For example, timestamp 10TS may include indication of a second, a minute, an hour, etc., and a time zone pertaining to the geographical location with respect to Coordinated Universal Time (UTC), e.g., UTC-7:00. A non-limiting example of a timestamp 10TS may be 01/01/2022 17:45:31 UTC+3:00.

In some embodiments, geographic location module 10 may send respective position data elements 10P, to processors associated with respective clients 100.

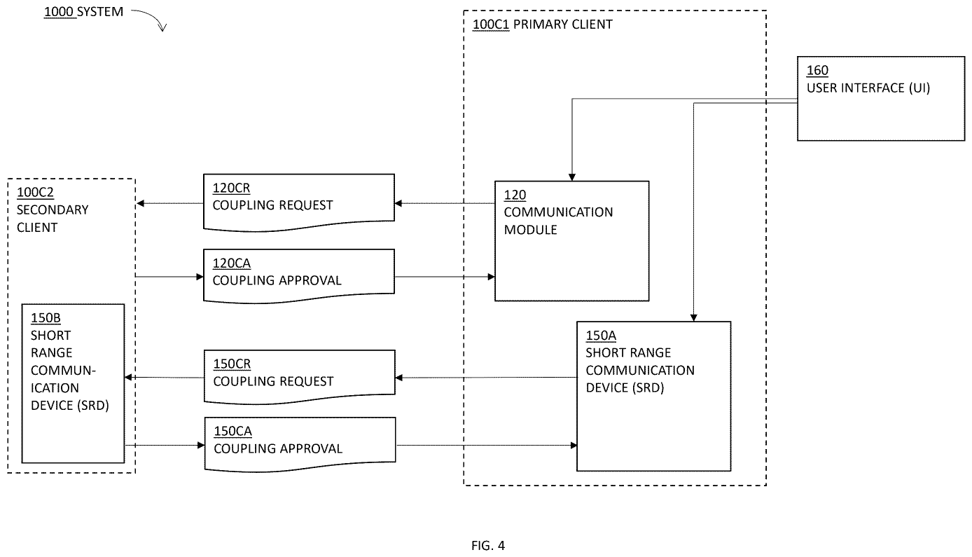

According to some embodiments, primary client 100C1 and one or more secondary clients 100C2 may be coupled via communication module 120 of system 1000, which may a long-range communication module, including for example a cellular communication module or modem. Additionally, or alternatively, primary client 100C1 and secondary client 100C2 may be coupled via a short-range communication module 150, as illustrated, and discussed herein in relation to FIG. 4. Non-limiting examples of short-range communication device 150 may include: a Wi-Fi device, a Bluetooth device, and a Near Field Communication (NFC) device.

As shown in FIG. 3, primary client 100C1 may include an analysis module 110. Analysis module 110 may be configured to receive (a) a primary position data element 10P-A from geographical location module 10A, and (b) a secondary position data element 10P-B from geographic location module 10B, via communication module 120. Analysis module 110 may determine a refined position data element 110RL (e.g., 110RL-A, 110RL-B), representing a geographic location of client 100 (e.g., 100C1, 100C2). Analysis module 110 may subsequently calculate refined position data element 110RL based on the received position data elements (e.g., 10P-A, 10P-B), as elaborated herein.

The term “refined” may be used in this context of refined position data element 110RL to indicate an improvement (e.g., an improvement of accuracy) with respect to a representation of geographic location. Refined position data element 110RL may be an improvement over currently available systems (e.g., clients 100C1 and 100C2) that only rely on receiving position data elements 10P (e.g., from a respective geographic location module 10).

Additionally, or alternatively, analysis module 110 may be configured to calculate a refined position data element 110RL-A representing a geographic location of primary client 100C1 based on at least one attribute of: confidence values 10CV-A, and timestamps 10TS-A.

For example, analysis module 110 may calculate a weighted average of position data elements 10P (e.g., 10P-A, 10P-B), based on said attributes. When confidence value 10CV-A is greater than confidence value 10CV-B, primary position data element 10P-A may have a greater weight 110W over secondary position data element 10P-B for calculating refined position data element 110RL. The example equation Eq. 1 below depicts a weighted average calculation, which may be used to calculate refined position data element 110RL:

$$\begin{matrix}( a ) & W = f ( CV ) \\ ( b ) & X = \frac{{W}_{1} {Y}_{1} + {W}_{2} {Y}_{2}}{{W}_{1} + {W}_{2}}\end{matrix} \qquad Eq . 1$$

In equation Eq. 1 (a), W is a weight value 110W, computed as a function of confidence value (CV) such as 10CV.

In equation Eq. 1 (b), W₁ and W₂ are instantiations of weight values 110W, computed separately, according to Eq. 1 (a), for each of two clients (e.g., 100C1, 100C2) respectively. Y1 and Y2 represent position data elements 10P-A and 10P-B, respectively. In other words, each position data element Y may have a respective confidence value W (10CV e.g., 10CV-A, 10CV-B). X represents a refined position data element 110RL, as a weighted average of position data elements (e.g., 10P-A and 10P-B).

Additionally, or alternatively, the example equation Eq. 2 below depicts another weighted average calculation, which may be used to calculate refined position data element 110RL:

$$\begin{matrix}( a ) & W = f ( C V , Δ T S ) \\ ( b ) & X = \frac{{W}_{1} {Y}_{1} + {W}_{2} {Y}_{2}}{{W}_{1} + {W}_{2}}\end{matrix} \qquad Eq . 2$$

In equation Eq. 2(a), W represents a weight value 110W, calculated as a function f( ) of attributes such as confidence value 10CV and timestamp 10TS, as elaborated herein.

In equation Eq. 2(b), X represents a refined position data element 110RL, and weight values 110W W₁ and W₂ may be calculated as functions of confidence value 10CV and timestamp 10TS, as in Eq. 2 (a).

For example, function f( ) may assign a first numerical weight value 110W, W₁, to a first client 10 (e.g., 10A) having a second confidence value 10CV and/or timestamp 10TS, and assign a second numerical weight value 110W, W₂, to a second client 10 (e.g., 10B) having a second confidence value 10CV and/or timestamp 10TS. Function f( ) may be configured such that weight 110W W₁ may be larger than weight 110W W₂ if the first confidence value 10CV is higher than the second confidence value 10CV. In another example, function f( ) may be configured such that weight 110W W₁ may be larger than W₂ if the first timestamp 10TS is later (e.g., more up-to-date) than the second timestamp 10TS.

X may be calculated as a weighted average of position data elements Y1 and Y2 (10P, e.g., 10P-A and 10P-B), each associated with a respective attribute (e.g., W₁ and W₂), respectively. Weight values 110W W₁ and W₂ may be used, for example, in order to weigh a corresponding position data element 10P (e.g., 10TS-A corresponding to 10P-A) over another position data element 10P.

Analysis module 110 may be configured to send refined position data element 110RL to secondary client 100C2 as refined position data element 110RL-B. As such, refined position data element 110RL-B may represent a geographical location of secondary client 100C2.

In some embodiments, client 100 (e.g., 100C1, 100C2) may send refined position data element 110RL (e.g., 110RL-A, 110RL-B) to a vehicle module 130 (e.g., 130A, 130B). Vehicle module 130 may be, or may include a software and/or hardware element, that may be associated with a vehicle, and may utilize refined position data element 110RL according to a specific configuration.

For example, vehicle module 130 may be associated with a controller of an autonomous vehicle, configured to control a steering system of said vehicle, control a braking system of said vehicle, control an accelerator of said vehicle, and the like, based on refined position data element 110RL.

In another example, vehicle module 130 may be associated with a processor of an advanced driver-assistance system (ADAS) of a vehicle, configured to produce, for example, a collision warning on a user interface associated with said vehicle.

In another example, vehicle module 130 may be, or may include: an ADAS system of a vehicle, an autonomous vehicle controller, an adaptive cruise control system of a vehicle, a pedestrian warning system installed on a vehicle, and a parking assist system of a vehicle.

Reference is now made to FIG. 4, which depicts a system 1000 for coupling of devices according to some embodiments of the invention. System 1000 of FIG. 4 may be the same as system 1000 of FIG. 2A and/or FIG. 2B and/or FIG. 3.

According to some embodiments of the invention, a user may use a user interface (UI) 160 to input a coupling request 120CR to primary client 100C1. Primary client 100C1 may receive coupling request 120CR, and may send or transmit a coupling request 120CR message, e.g., via communication module 120, either directly or via server 100S to a second computing device 100C2, based on the input coupling request 120CR. Primary client 100C1 may subsequently receive a coupling approval message 120CA from second computing device 100C2 and couple clients 100C1 and 100C2 based on the reception of coupling approval message 120CA.

Primary client 100C1 may subsequently send a signal to user interface 160 displaying a confirmation of coupling devices based on receiving coupling approval 120CA message from communication module 120.

Additionally, or alternatively primary client 100C1 may send a coupling request 150CR, e.g., via a primary short-range communication device (SRD) 150A associated with primary client 100C1, to a secondary SRD device 150B of a secondary client computing device 100C2. Client 100C1 may subsequently receive a coupling approval 150CA message from secondary client computing device 100C2, and couple clients 100C1 and 100C2 based on the received approval 150CA message.

Primary client 100C1 may then send a signal to user interface 160 displaying a confirmation of coupling devices based on receiving a coupling approval 150CA from primary SRD 150. Said primary SRD 150A may be configured to detect at least one secondary SRD 150B associated with at least one secondary client 100C2, in order to couple clients 100C1 and 100C2. Non-limiting examples of a short-range communication device 150A or 150B may include: a Wi-Fi device, a Bluetooth device, and an NFC device.

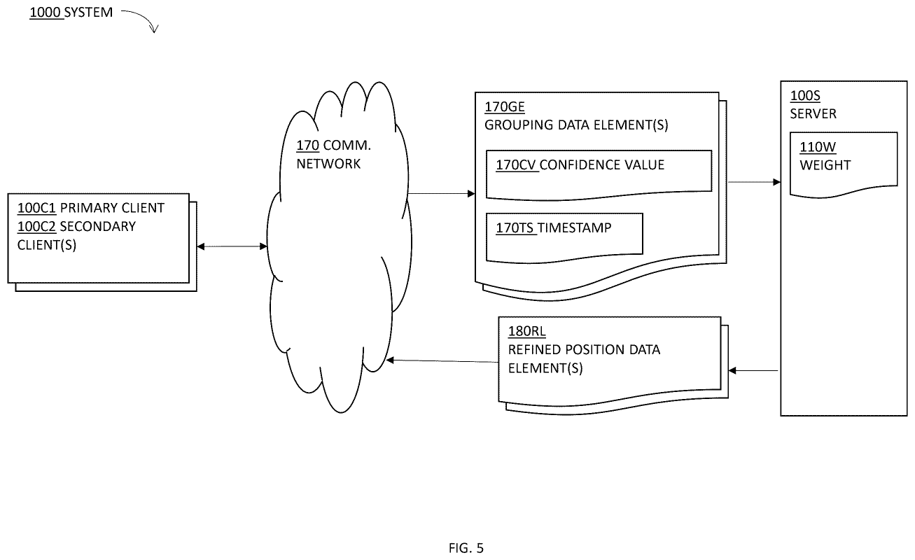

Reference is now made to FIG. 5, which depicts a system for determining a geographical location according to some embodiments of the invention. System 1000 of FIG. 5 may be the same as system 1000 of FIG. 2A, FIG. 2B, FIG. 3, and/or FIG. 4.

Server 100S may be an embodiment of computing device 1 illustrated and discussed herein with respect to FIG. 1. Server 100S may be communicatively connected to primary clients 100C1 and/or secondary clients 100C2 via a communication network 170.

Server 100S may receive at least one grouping data element 170GE representing a cluster of one or more client computing devices 100 (e.g., 100C1, 100C2). Grouping data element 170GE may be sent to server 100S, for example, via communication network 170. Grouping data element 170GE may be determined by a geographic location module (e.g., geographic location module 10) associated with one or more client computing devices 100 (e.g., 100C1, 100C2). Geographic location module 10, or a respective client associated with geographic location module 10 may be configured to provide a grouping data element 170GE to server 100S. In some embodiments, grouping data element 170GE may be received by server 100S via an input device associated thereof (e.g., input device 7 of FIG. 1). Optionally, grouping data element 170GE may include a confidence value 170CV and a timestamp 170TS.

Server 100S may determine a refined position data element 180RL, representing a geographical location of the cluster of one or more client computing devices. Server 100S may determine refined position data element 180RL based on the at least one grouping data element 170GE. Additionally, or alternatively, server 100S may determine refined position data element 180RL based on the confidence value 170CV and/or the timestamp 170TS.

For example, server 100S may determine refined position data element 180RL based on a weighted average calculation of the one or more grouping data elements 170GE. Said weighted average calculation may be, or may include elements or functions discussed herein with respect to a weighted average calculation performed by analysis module 110 of system 100, discussed herein with respect to FIG. 3.

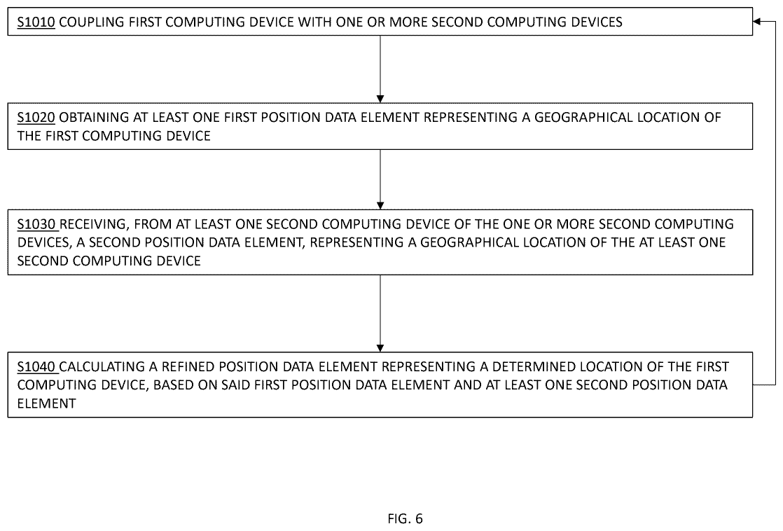

Reference is now made to FIG. 6, which depicts a flowchart of a method of determining a geographical location of a computing device, by at least one processor, according to some embodiments of the invention. Steps S1010 to S1040 may be performed by system 1000, to determine one or more refined position data elements 110RL (e.g., 110RL-A, 110RL-B) representing geographical locations of computing devices 100 (e.g., 100C1, 100C2). Steps S1010 to S1040 may be used to determine one or more refined position data elements 110RL, for example, via a communication network 170 communicatively connected to one or more computing devise 100 (e.g., 100C1, 100C2). Additionally, or alternatively, steps S1010 to S1040 may be performed by server 100S, to determine one or more refined position data elements 180RL representing a geographical location of a cluster of computing devices 100 (e.g., 100C1, 100C2).

In step S1010, a first computing device (e.g., 100C1) may be coupled with one or more second computing devices (e.g., 100C2). First computing device 100C1 may be coupled with one or more second computing devices 100C2 according to instructions discussed herein, for example, via a communication module 120 or a short-range communication device 150 (e.g., 150A, 150B).

For example, a first computing device 100C1 may be coupled with one or more computing devices 100C2 via a short-range communication device 150, e.g., a Bluetooth connection.

In step S1020, at least one first position data element 10P (e.g., 10P-A) may be obtained, wherein said first position data element 10P-A represents a geographical location of the first computing device 100C1. In some embodiments, the first position data element 10P-A may include one or more attributes (e.g., confidence value 10CV-A, timestamp 10TS-A).

For example, the first position data element 10P-A may be obtained via a geographical location module 10 associated with the first computing device 100C1.

In step S1030, a second position data element 10P (e.g., 10P-B) may be received from at least one second computing device 100C2 of the one or more second computing devices 100C2, wherein the second position data element 10P-B represents a geographical location of the at least one second computing device 100C2. In some embodiments, the second position data element 10P-B may include one or more attributes (e.g., confidence value 10CV-B, timestamp 10TS-B).

For example, the second position data element 10P-B may be obtained via a geographical location module 10 associated with the second computing device 100C2.

In step S1040, a refined position data element 110RL may be calculated based on said first and at least one second position data element 10P (e.g., 10P-A, 10P-B), wherein the refined position data element 110RL represents a determined geographical location of the first computing device 100C1. Refined position data element 110RL may be sent to the at least one second computing device 100C2, in order to represent a geographical location of the at least one second computing device 100C2.

For example, refined position data element 110RL may be calculated based on elements or functions discussed herein with respect to a weighted average calculation performed by analysis module 110 of system 100, discussed herein with respect to FIG. 3. As such, step 1040 may include calculating refined position data element 110RL based on first and at least one second position data element 10P-A and 10P-B, by performing said weighted average calculation with respect to received position data elements 10P (e.g., 10P-A, 10P-B).

According to some embodiments of the invention, method steps S1010 to S1040 discussed herein may be repeated, for example, in order to recalculate a position data element representing a geographical location of primary client 100C1, i.e., an iterative loop. In some embodiments, in each iteration, one or more clients 100 (e.g., 100C2) may be coupled to primary client 100C1. Said clients 100C2 may send primary client 100C1 at least one position data element 10P-B, representing a geographical location of the at least one coupled client 100C2. Refined position data element 110RL may be based on the one or more position data elements 10P-B. Refined position data element 110RL may be based on confidence values 10CV-B associated with the one or more position data elements 10P-B. Additionally, or alternatively, refined position data element 110RL may be based on timestamps 10TS-B associated with the one or more position data elements 10P-B. In some embodiments, said iterative loop may repeat, for example, until a certain threshold of refined position data element 110RL is achieved (i.e., a convergence of iteration).

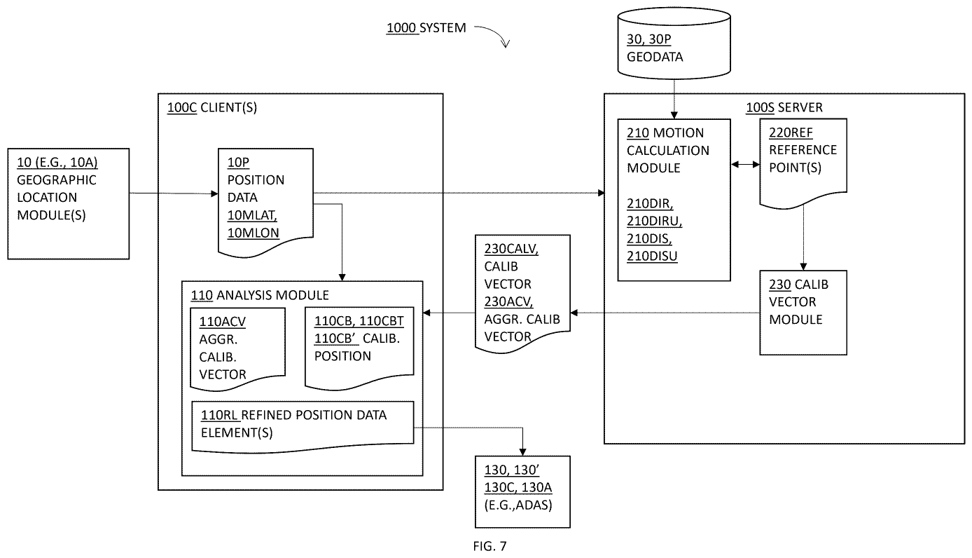

Reference is now made to FIG. 7, which depicts modules of a system 1000 for determining a geographical location of one or more computing devices, according to some embodiments of the invention. System 1000 of FIG. 7 may be the same as system 1000 of FIG. 2A, FIG. 2B and/or FIG. 3. Some arrows have been omitted in FIG. 6 for the purpose of clarity.

As shown in FIG. 7, server 100S of system 1000 may include, or may be communicatively connected (e.g., via network 170) to a geodata database 30. Database 30 may include a plurality of geodata points 30P, each representing a geographical location, and attributed ground-truth longitude and latitude values.

As elaborated herein, server 100S may include a motion calculation module 210 (or “motion module 210” for short) configured to select one or more geodata points 30P according to predefined criteria, to obtain therefrom one or more reference points 220REF. Each reference point 220REF may represent a geographical location, and may be attributed ground-truth longitude and latitude values.

As elaborated herein, clients 100C may receive, for associated geographic location units 10, one or more position data elements 10P (e.g., repeatedly, over time). Each position data element 10P may include measured longitude and latitude values of that client computing device 100C. Server 100S may be communicatively connected to clients 100C, and may receive from at least one client computing device 100C, at least two such position data elements 10P.

Based on the at least two position data elements, motion module 210 may determine a direction of motion 210DIR of client computing device 100C. For example, direction of motion 210DIR may be calculated as a vector that connects between the geographical locations represented by two or more position data elements 10P.

Additionally, or alternatively, based on the at least to position data elements 10P, motion module 210 may calculate a minimal traversal distance 210DIS between the client computing device and a geographical location of a specific reference point 220REF. For example, minimal traversal distance 210DIS may be calculated as a vector that is perpendicular to the vector of direction of motion 210DIR, and intersects the specific reference point 220REF.

As shown in FIG. 7, server 100S may include a calibration vector calculation module 230 (or “calibration module 230” for short). Calibration module 230 may be configured to produce a reference-specific calibration vector 230CALV, for client 100C, based on the minimal traversal distance vector 210DIS.

Calibration vector 230CALV may represent a required correction of location of the at least one client computing device 110C in a direction substantially perpendicular to the direction of motion 210DIR.

In a trivial example, calibration vector 230CALV may pertain to the specific reference point 220REF, and may be opposite to the respective minimal traversal distance 210DIS vector (e.g., perpendicular to direction of motion 210DIR). For example, a vehicle which is conducted on an east-west axis, may traverse a specific reference point 220REF. At the closest point from reference point 220REF, minimal distance vector 210DIS of client 100C may represent an offset distance (e.g., by a few meters) from reference point 220REF, in a northern direction. Calibration vector 230CALV may include an indication of required correction, in an opposite direction to minimal distance vector 210DIS, e.g., southwards, by the same offset distance.

In another example, and as elaborated further herein, calibration vector 230CALV may represent a required correction of location for a client device 100C, based on a timewise aggregation of reference points 220REF. In such embodiments, calibration vector 230CALV may not necessarily represent a required correction of location that is substantially perpendicular to direction of motion 210DIR. Such calculation of an aggregated calibration vector may be similarly performed by server 100S (denoted 230ACV) for one or more clients 100C, and/or by one or more (e.g., each) client computing devices 100C (denoted 110ACV) for their respective locations.

For example, calibration module 230 may produce a plurality of reference-specific calibration vectors 230CALV associated with a specific client device 100C. Each calibration vector 230CALV may pertain to a respective, unique reference point 220REF, and may be obtained as client device 100C traverses reference points 220REF over time.

Server 100C may calculate an aggregate calibration vector 230ACV for the respective client device 100C, based on the plurality of reference-specific calibration vectors 230CALV. Additionally, or alternatively, server 100C may communicate reference-specific calibration vectors 230CALV to the respective client 100C, which may employ analysis module 110 to calculate aggregate calibration vector 110ACV based on the plurality of reference-specific calibration vectors 230CALV.

In one example, aggregate calibration vectors 110ACV/230ACV may be calculated as an average vector of all reference-specific calibration vectors 230CALV pertaining to a specific client device 100C.

In another example, aggregate calibration vectors 110ACV/230ACV may be calculated as an average vector of all reference-specific calibration vectors 230CALV pertaining to one or more (e.g., all) client devices 100C.

In another example, each reference-specific calibration vectors may be attributed a traversal timestamp, representing a time at which the respective client computing device 100C was at the minimal traversal distance from the geographical location of the respective reference point 220REF. In such embodiments, calibration module 230 and/or analysis module 110 of the respective client computing device 100C may calculate the aggregate calibration vector 110ACV/230ACV further based on the traversal timestamps. For example, client 100C may calculate aggregate calibration vector 110ACV as a weighted average vector of all reference-specific calibration vectors 230CALV, by using the timestamps as diminishing weights, to give old measurements a lesser weight in the calculation.

According to some embodiments, client 100C may receive (e.g., from geolocation module 10) an instant position data element 10P that may include current measured values of longitude and latitude of the client computing device 100C. Client 100C may apply aggregate calibration vector 110ACV/230ACV on the instant position data element 10P, to obtain a calibrated position data element 110CB. Calibrated position data element 110CB may represent a corrected geographical location of the client computing device 100C.

The term “apply” may be used herein to indicate correction of the latitude and longitude values of instant position data element 10P as indicated by aggregate calibration vector 110ACV/230ACV. For example, an aggregate calibration vector 110ACV/230ACV that represents X meters in an easterly direction and Y meters in a northernly direction may be applied to instant position data element 10P by adding X and Y to the latitude and longitude values of data element 10P respectively.

Additionally, or alternatively, aggregate calibration vector 110ACV/230ACV may be trivial, in a sense that it may represent a specific reference point 220REF, and thus be equivalent to reference-specific calibration vector 230CALV. In such embodiments, analysis module 110 may apply the reference-specific calibration vector 230CALV on the instant position data element 10P to obtain calibrated position data element 110CB.

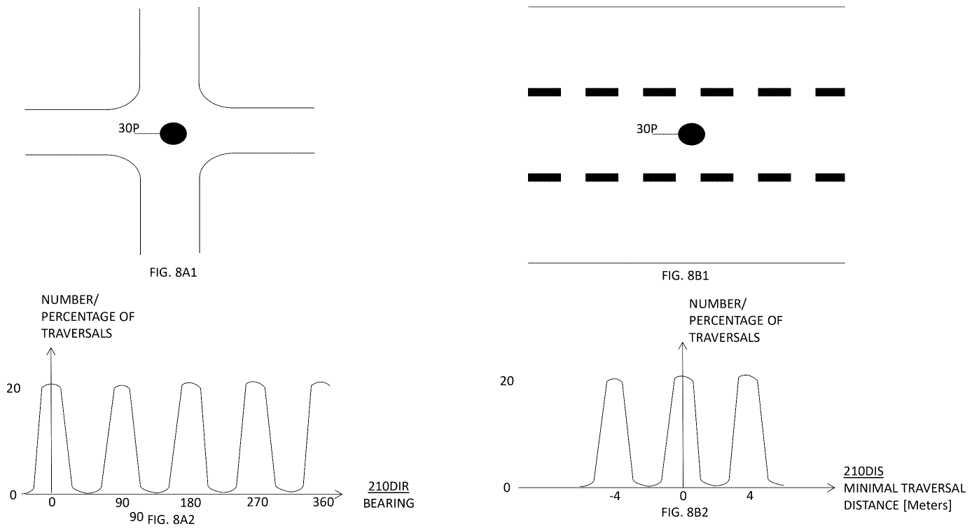

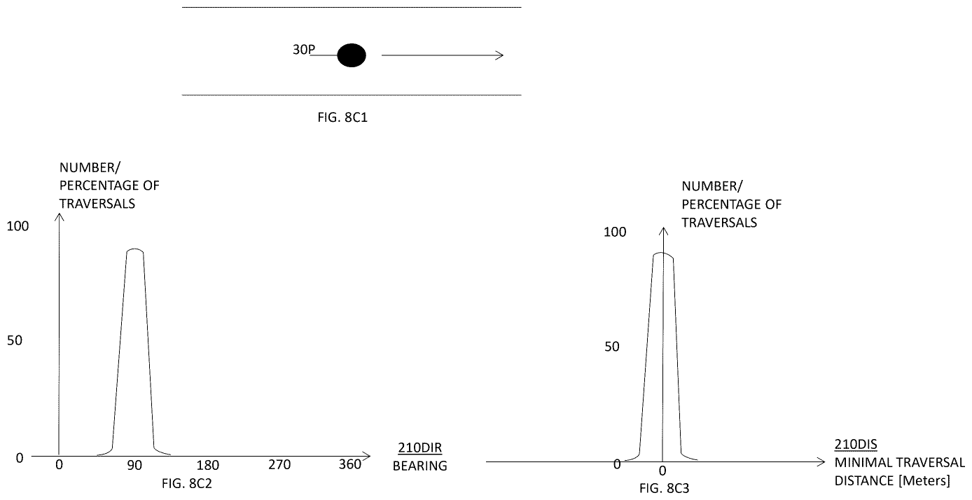

Reference is now made to FIGS. 8A1, 8A2, 8B1, 8B2, 8C1, 8C2 and 8C3 which are schematic graphs, illustrating criteria for selection of geodata points 30P according to predefined criteria, to obtain therefrom one or more reference points 220REF, according to some embodiments of the invention.

As shown in FIG. 8A1, a geodata point 30P may represent a geographical location (e.g., latitude and longitude) of a middle of a crossroad. In such a condition, the bearing or direction 210DIR of vehicles carrying client devices 100C may be schematically represented as in FIG. 8A2. As shown in that figure, direction 210DIR may not be uniform, in a sense that it may be distributed about four different bands (e.g., around 0, 180, 270 and 360 bearing degrees). Therefore, geodata point 30P of FIG. 8A1 may not be selected as a reference point 220REF.

As shown in FIG. 8B1, a geodata point 30P may represent a geographical location (e.g., latitude and longitude) of a middle of a multiple (e.g., three) lane road, where the width of each lane is 4 meters. In such a condition, offset of a minimal traversal distance vector 210DIS of vehicles carrying client devices 100C may be schematically represented as in FIG. 8B2. As shown in that figure, distance 210DIS may not be uniform, in a sense that it may be distributed about three different bands (e.g., around −4, 0, and 4 meters) in an axis that is perpendicular to direction of motion 210DIR. Therefore, geodata point 30P of FIG. 8B1 may not be selected as a reference point 220REF.

As shown in FIG. 8C1, a geodata point 30P may represent a geographical location (e.g., latitude and longitude) of a middle of a single lane road. In such a condition, the bearing or direction 210DIR of vehicles carrying client devices 100C near point 30P may be schematically represented as in FIG. 8C2, and offset of a minimal traversal distance vector 210DIS of vehicles carrying client devices 100C may be schematically represented as in FIG. 8C3. As shown in FIGS. 8C2 and 8C3, direction 210DIR and distance 210DIS may be uniform, in a sense that they may be defined around narrow bands of bearing (210DIR) and distance (210DIS) respectively. Therefore, geodata point 30P of FIG. 8C1 may be appropriately selected as a reference point 220REF.

According to some embodiments, motion module 210 may select geodata points of dataset 30 as reference points 220REF, in line with the explanations brought herein, e.g., in relation to FIGS. 8A1, 8A2, 8B1, 8B2, 8C1, 8C2 and 8C3.

In other words, motion module 210 may receive a dataset 30 of geodata points 30P, each representing a respective geographical location, and may include ground-truth longitude and latitude value. For one or more geodata points 30P, motion module 210 may calculate a direction uniformity value 210DIRU based on the position data elements 10P. Direction uniformity value 210DIRU may represent a level of uniformity of direction of motion 210DIR of client computing devices within a predetermined vicinity of the respective geographical location 30P. Motion module 210 may subsequently select the reference point 220REF among the plurality of geodata points 30P based on the direction uniformity values 210DIRU, e.g., when 210DIRU surpasses a predefined threshold.

Additionally, or alternatively, motion module 210 may calculate, for one or more geodata points 30P a distance uniformity value 210DISU based on the position data elements 10P. The distance uniformity value 210DISU may represent a level of uniformity of minimal traversal distances 210DIS between client computing devices 100C and the geodata point 30P. Motion module 210 may subsequently select the reference point 220REF among the plurality of geodata points 30P further based on the distance uniformity values 210DISU, e.g., when 210DISU surpasses a predefined threshold.

As elaborated herein, (e.g., in relation to FIGS. 2A, 2B and 3-6) one or more client devices 100C of system 1000 may use position data elements 10P (e.g., geoinformation measured by geolocation modules 10) to calculate a refined position data element 110RL. According to some embodiments, one or more client devices 100C may replace measured position data elements 10P with respective calibrated position data elements 110CB, for calculating refined position data element 110RL.

For example, a first client computing device 100C (e.g., 100C1) may obtain a calibrated position data element 110CB, representing a corrected geographical location of the first client computing device as elaborated herein. The first client computing device 100C1 may couple with one or more second client computing devices 100C (e.g., 100C2), and receive, from at least one second client computing device 100C2 a second calibrated position data element 110CB, representing a corrected geographical location of the at least one second computing device 100C2.

The first client computing device 100C1 may subsequently calculate a first refined position data element 110RL representing a refined location of the first computing device 100C1, based on (e.g., as a weighted average of) the first calibrated position data element 110CB and the at least one second calibrated position data element 110CB.

According to some embodiments, calibrated position data element 110CB, originating from position data element 10P may include, or may be attributed a position confidence value 110CB′, representing a reliability of the corrected geographical location of the respective client computing device 100C. Confidence value 110CB′ may, for example be a function of confidence value 10CV of the original position data element 10P, e.g., where a high confidence value confidence value 10CV may result in a high confidence value 110CB′.

Additionally, or alternatively, Confidence value 110CB′ may be a function of minimal traversal distance 210DIS, e.g., where a large correction of distance results in a low confidence value 110CB′.

In other words, a first calibrated position data element 110CB may be associated with a first minimal traversal distance value 210DIS, and at least one second calibrated position data element 110CB may be associated with at least one respective second minimal traversal distance value 210DIS. Client computing device 100C (e.g., 100C1) may calculate the refined position data element 1110RL further based on the first minimal traversal distance 210DIS value and the at least one second minimal traversal distance value 210DIS.

According to some embodiments, a first calibrated position data element 110CB may include a first confidence value 110CB′ and at least one second calibrated position data element 110CB may include at least one respective second confidence value 110CB′. In such embodiments, Client computing device 100C (e.g., 100C1) may calculate refined position data element 110RL further based on the first confidence value 110CB′ and the at least one second confidence value 110CB′. For example, client computing device 100C may calculate refined position data element 110RL as a weighted average of the first calibrated position data element 110CB and the at least one second calibrated position data element 110CB, using the confidence values 110CB′ as weights.

Additionally, or alternatively, the first calibrated position data element 110CB may include, or may be associated with a first timestamp, corresponding to the geographical location of the first computing device 100C1, and the at least one second calibrated position data element may include, or may be associated with at least one respective second timestamp, corresponding to the geographical location of the at least one second computing device 100C2. The first client computing device may calculate refined position data element 110RL further based on the first timestamp 110CBT and the at least one second timestamp 110CBT.

For example, client computing device 100C1 may calculate refined position data element 110RL as a weighted average of calibrated position data element 110CB, while using timestamps 110CBT as weights for this calculation, e.g., giving newer calibrated position data elements 110CB bigger weight in relation to older calibrated position data elements 110CB.

Additionally, or alternatively, client computing device 100C1 may project a future location of computing device 100C1 and computing device 100C2 based on (i) calibrated position data elements 110CB, (ii) the respective direction vectors 210DIR, and (iii) timestamps 110CBT. Client computing device 100C1 may calculate refined position data element 110RL as a weighted average of, and calculate refined position data element 110RL as a weighted average of the future locations.

As shown in FIG. 7, client computing device 100C may include at least one processor (e.g., processor 2 of FIG. 1) that may be associated with, or communicatively connected to a controller 130C (e.g., processor 2 of FIG. 1) of a vehicle module 130 that is included in a respective vehicle. Vehicle module 130 of FIG. 7 may be the same as vehicle module 130 of FIG. 3.

Client computing device 100C may send, or transmit refined position data element 110RL to controller 130C of vehicle module 130. Controller 2 of vehicle module 130 may, in turn, utilize refined position data element 110RL to perform one or more actions related to the respective vehicle. For example, vehicle module 130 may include an electric motor or attenuator 130A, controlled by controller 130C. Attenuator 130A may thus control a steering system of the vehicle, control a braking system of the vehicle, controlling an accelerator of the vehicle, and the like.

Additionally, or alternatively, controller 130C of a first client device 100C (e.g., 100C1) may be included in an ADAS system of the respective vehicle. Controller 130C may receive (e.g., via sever 100S) one or more refined position data elements 110RL pertaining to other client devices 100C (e.g., 100C2). Controller 130C may thus assess vicinity of client module 100C1 to the other client devices 100C2 (e.g., other vehicles), and/or produce a collision warning on a user interface of the respective vehicle.

Additionally, or alternatively, controller 130C of a first client device 100C (e.g., 100C1) may transmit refined position data elements 110RL to at least one second client device 100C (e.g., 100C2) that may be coupled to the first client device 100C1, as elaborated herein. In such embodiments, the at least one second client device 100C2 may use the refined position data element 110RL of first client device 100C1 to represent (e.g., as representing) its own geographical location, e.g., on a UI of client device 100C2.

Additionally, or alternatively, the second computing device 100C2 may be associated with a second vehicle module 130′, e.g., of a second vehicle. In such embodiments, second vehicle module 130′ may be configured to utilize the refined position data element 110RL (e.g., of first client device 100C1) to perform at least one of: control a steering system of the second vehicle, control a braking system of the second vehicle, control an accelerator of the second vehicle, produce a collision warning on a user interface of the second vehicle, and any combination thereof.

According to some embodiments, first client computing device 100C (e.g., 100C1) and the at least one second client computing device(s) 100C (e.g., 100C2) may negotiate a role of a primary client computing device, based on the first confidence value (e.g., 170CV of FIG. 3) of client computing device 100C1 and the at least one second confidence value 170CV of the at least one second client computing device 100C2.

For example, a role of a primary client computing device may be assigned to a specific client computing device 100C which has a maximal confidence value 170CV. Additionally, or alternatively, a role of a primary client computing device may be assigned to a client computing device 100C which has superior computing (e.g., processing, memory and/or communication) resources. In yet another example, a role of a primary client computing device may be assigned to a client computing device 100C which is in communication to a superior number of other client computing devices 100C.

The primary client computing device may be configured to provide a majority of computing power to determine refined position data elements 110RL (e.g., the refined geographical locations) of that client computing device 100C and/or at least one other client computing devices 100C.

According to some embodiments, the calculation of refined position data element 110RL may be done iteratively (e.g., repeatedly, over plurality of iterations). In each iteration client computing device 100C1 may calculate a first refined position data elements 110RL and a corresponding confidence value, representing reliability of the refined geographical location 110RL of the first computing 100C1 device in that iteration.

Client computing device 100C1 may subsequently calculate a summary refined position data element representing a determined location of the first computing device, based on the plurality of first position data elements (e.g., from a plurality of iterations), and the respective plurality of confidence values.

For example, one or more (e.g., each) of the plurality of first refined position data elements 110RL may include, or may be associated with a timestamp, corresponding to the geographical location of the first computing device 100C1 in that iteration. Client computing device 100C1 may calculate the summary refined position data element 110RL based (e.g., as a weighted sum of) first refined position data elements 110RL, where the plurality of timestamps may be used to calculate diminishing weight values (e.g., assigning diminishing value to position data elements 110RL as time passes).

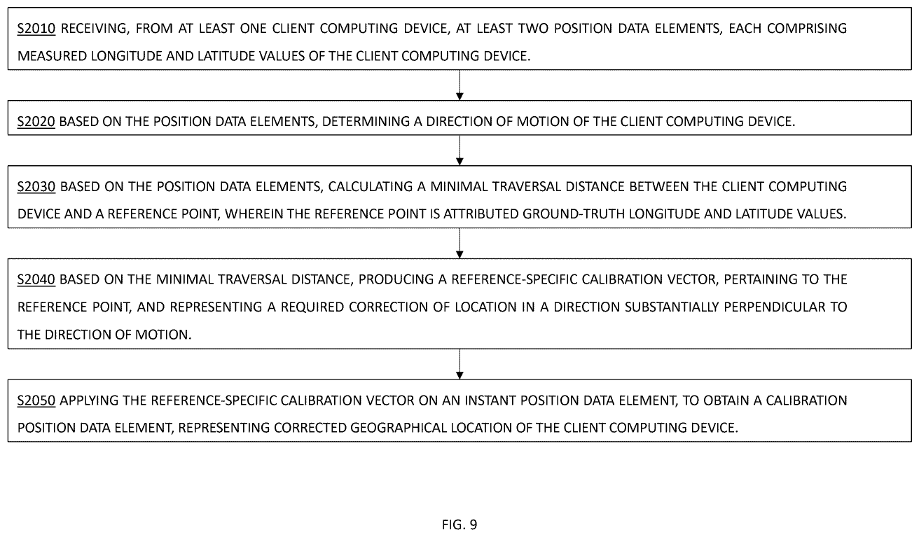

Reference is now made to FIG. 9, which depicts a flowchart of a method of determining a geographical location of a client computing device, by at least one processor (e.g., processor 2 or FIG. 1), according to some embodiments of the invention.

As shown in step S2010, the at least one processor 2 may be a processor of a server device (e.g., server 100S of FIG. 7). Processor 2 may receive, e.g., from at least one client computing device (e.g., client 100C of FIG. 7), at least two position data elements 10P. Each position data elements 10P may include measured longitude 10MLON and latitude 10MLAT values of the client computing device 100C.

As shown in step S2020, based on the position data elements 10P (e.g., on 10MLON and 10MLAT values), processor 2 of server 100S may determine a direction of motion of the client computing device, e.g., as a vector 210DIR that connects the geographical locations of 10MLON and 10MLAT of the two or more position data elements 10P.

Additionally, or alternatively, and as shown in step S2030, based on the position data elements 10P, processor 2 of server 100S may calculate a minimal traversal distance 210DIS between the client computing device and a reference point 220REF, as elaborated herein. Reference point 220REF may represent, or may be attributed ground-truth longitude and latitude values of a specific geographical location.

As shown in step S2040, based on the minimal traversal distance 220DIS, processor 2 of server 100S may produce a reference-specific calibration vector 230CALV, pertaining to the reference point 220REF. Reference-specific calibration vector 230CALV may represent a required correction of location in a direction substantially perpendicular to the direction of motion 210DIR.

As shown in step S2050, server 100S and/or client 100C may apply the reference-specific calibration vector 230CALV on an instant position data element 10P, to obtain a calibration position data element 110CB, representing corrected geographical location of the client computing device 100C.

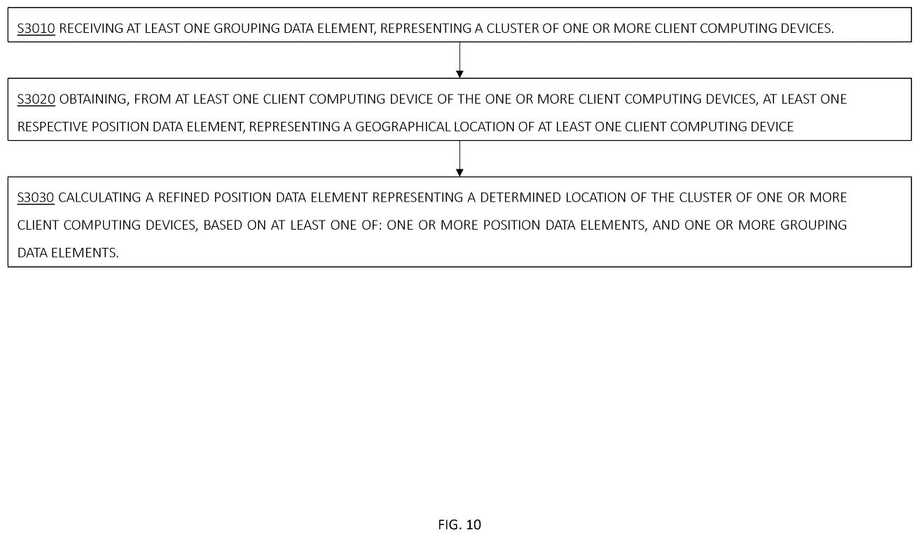

Reference is now made to FIG. 10, which depicts a flowchart of a method of determining, by at least one processor of a server computing device, a geographical location of one or more client computing devices, according to some embodiments.

As shown in step S3010, the at least one processor (e.g., processor 2 or FIG. 1) may receive at least one grouping data element (e.g., grouping data element 170GE of FIG. 5), representing a cluster of one or more client computing devices 100C.

As shown in step S3020, the at least one processor 2 may obtain, from at least one client computing device 100C of the one or more client computing devices 100C, at least one respective position data element 10P, representing a geographical location of at least one client computing device 100C (e.g., a computing device 100C pertaining to the cluster).

As shown in step S3030, the at least one processor 2 may calculate a refined position data element 110RL representing a determined location of the cluster of one or more client computing devices 100C (e.g., as represented by grouping data element 170GE), based on at least one of: (i) the one or more position data elements 10P, and (ii) the one or more grouping data elements 170GE.

### Improvement of Technology

Embodiments of the invention may provide a practical application for calibrating geographical location measurement, e.g., produced by a geographic location module (e.g., element 10 of FIG. 3) such as a GPS receiver, as elaborated herein.

Embodiments of the invention may also provide a practical application for calculating a representation of a geographical location of a computing device. For example, embodiments of the invention may be used to refine the location of a computing device, as relayed to the end user (i.e., a navigational application of a smartphone).

Embodiments of the invention may improve a computing device's representation of its geographical location over currently available solutions for determining geographical locations, for example, by coupling the computing device with other computing devices and transferring position data. In one example, an ADAS module 130 associated with a vehicle may detect a proximate coupled computing device of an oncoming pedestrian, and may control the vehicle to avoid an accident.

In another example, a first smartphone with a low reliability (i.e., a low confidence value, as discussed herein) of its geographical location may refine its location by coupling with a second smartphone with a high reliability of its geographical location. By taking a weighted average of the two position data elements, the first smartphone may obtain a refined position data element containing an increased reliability of its geographical location.

In another example, a first ADAS module 130 associated with a first vehicle may couple with a second ADAS 130 module associated with an oncoming second vehicle. By transferring position data corresponding to each vehicle, each ADAS module 130 may improve a response time on its collision warning system, as opposed to conventional methods of using distance sensors (e.g., cameras mounted to the vehicle).

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A system for determining a geographical location, the system comprising a server computing device configured to:
obtain one or more reference points, each representing a geographical location, and attributed ground-truth longitude and latitude values;
receive, from at least one client computing device, at least two position data elements, each comprising measured longitude and latitude values of the client computing device;
based on the position data elements, determine a direction of motion of the client computing device;
based on the position data elements, calculate a minimal traversal distance between the client computing device and a geographical location of a specific reference point; and
based on the minimal traversal distance, produce a reference-specific calibration vector, pertaining to the specific reference point, and representing a required correction of location of the at least one client computing device in a direction substantially perpendicular to the direction of motion.

2. The system of claim 1, wherein the server computing device is further configured to transmit the reference-specific calibration vector to the client computing device, and wherein the at least one client computing device is configured to:
receive an instant position data element comprising measured values of longitude and latitude of the client computing device; and
apply the reference-specific calibration vector on the instant position data element, to obtain a calibrated position data element, representing a corrected geographical location of the client computing device.

3. The system of claim 1, wherein the server computing device is configured to produce a plurality of reference-specific calibration vectors, each pertaining to a respective, unique reference point, and wherein the at least one client computing device is configured to:
calculate an aggregate calibration vector based on the plurality of reference-specific calibration vectors; and
apply the aggregate calibration vector on the instant position data element, to obtain the calibrated position data element.

4. The system of claim 3, wherein each reference-specific calibration vectors is attributed a traversal timestamp, representing a time at which the client computing device was at the minimal traversal distance from the geographical location of the respective reference point, and wherein the client computing device is configured to calculate the aggregate calibration vector further based on the traversal timestamps.

5. The system of claim 1, wherein the server computing device is configured to obtain a reference point by:
receiving a dataset comprising a plurality of geodata points, each representing a respective geographical location, and comprising ground-truth longitude and latitude values;
for one or more geodata points, calculating a direction uniformity value based on the position data elements, wherein the direction uniformity value represents a level of uniformity of direction of motion of client computing devices within a predetermined vicinity of the respective geographical location; and
selecting the reference point among the plurality of geodata points, based on the direction uniformity values.

6. The system of claim 5, wherein the server computing device is further configured to:
for one or more geodata points, calculating a distance uniformity value based on the position data elements, wherein the distance uniformity value represents a level of uniformity of minimal traversal distances between client computing devices and the geodata point; and
selecting the reference point among the plurality of geodata points, further based on the distance uniformity values.

7. The system of claim 2, wherein the at least one client computing device comprises a first client computing device, and one or more second client computing devices, and wherein the first client computing device is configured to:
couple with the one or more second client computing devices;
obtain a calibrated position data element, representing a corrected geographical location of the first client computing device;
receive, from at least one second computing device of the one or more second computing devices a second calibrated position data element, representing a corrected geographical location of the at least one second computing device; and
calculate a first refined position data element representing a refined location of the first computing device, based on the first calibrated position data element and the at least one second calibrated position data element.

8. The system of claim 7, wherein the first calibrated position data element comprises a first confidence value, representing a reliability of the corrected geographical location of the first client computing device, and wherein the at least one second calibrated position data element comprises at least one respective second confidence value, representing a reliability of the geographical location of the at least one second computing device, and wherein the first client computing device is configured to calculate the first refined position data element further based on the first confidence value and the at least one second confidence value.

9. The system of claim 7, wherein the first calibrated position data element comprises a first timestamp, corresponding to the geographical location of the first computing device, and wherein the at least one second calibrated position data element comprises at least one respective second timestamp, corresponding to the geographical location of the at least one second computing device, and wherein the first client computing device is configured to calculate the refined position data element further based on the first timestamp and the at least one second timestamp.

10. The system of claim 7, wherein the first calibrated position data element is associated with a first minimal traversal distance value, and wherein the at least one second calibrated position data element is associated with at least one respective second minimal traversal distance value, and wherein the first client computing device is configured to calculate the refined position data element further based on the first minimal traversal distance value and the at least one second minimal traversal distance value.

11. The system of claim 7, wherein the first computing device is configured to transmit the refined position data element to at least one controller of a vehicle module of a vehicle, and wherein the vehicle module is configured to utilize the refined position data element to perform at least one of: control a steering system of the vehicle; control a braking system of the vehicle; control an accelerator of the vehicle; producing a collision warning on a user interface of the vehicle; and any combination thereof.

12. The system of claim 7, wherein the first computing device is configured to transmit the refined position data element to at least one second computing device of the one or more second computing devices, and wherein the at least one second computing device is configured to use the refined position data element to represent its geographical location, and wherein the at least one second computing device of the one or more second computing devices is associated with a vehicle module of a vehicle, and wherein the vehicle module is configured to utilize the refined position data element to perform at least one of: control a steering system of the vehicle; control a braking system of the vehicle; control an accelerator of the vehicle; produce a collision warning on a user interface of the vehicle; and any combination thereof.

13. (canceled)

14. The system of claim 7, wherein the first client computing device is configured to couple with the one or more second client computing devices by:
receiving, via a user interface (UI) of the first computing device a coupling request;
sending a coupling request message to the second computing device, based on said coupling request;
receiving a coupling approval message from the second computing device; and
coupling with the second client computing device based on said approval message.

15. The system of claim 7, wherein the first client computing device is configured to couple with the one or more second client computing devices by:
using a first short range communication device (SRD) associated with the first computing device to detect at least one second SRD associated with the at least one second computing device;
sending a coupling request message via the first SRD to the at least one second SRD;
receiving a coupling approval message from the at least one second computing device via the first SRD; and
coupling the first computing device with the at least one second computing device via the first SRD,
wherein the first SRD is selected from a list consisting of a Wi-Fi device, a Bluetooth device, and a Near Field Communication (NFC) device.

16. (canceled)

17. The system of claim 8, wherein the first client computing device and the at least one second client computing devices are configured to negotiate a role of a primary client computing device, based on the first confidence value and the at least one second confidence value, and wherein the primary device is configured to provide a majority of computing power to determine the refined geographical locations of the first client computing device and the at least one second client computing device.

18. The system of claim 7, wherein the first client computing device is configured to:
repeat calculation of the first refined position data element in a plurality of iterations, to obtain a respective plurality of (i) first refined position data elements, and (ii) corresponding confidence values, representing reliability of the refined geographical location of the first computing device in that iteration; and
calculate a summary refined position data element representing a determined location of the first computing device, based on the plurality of first position data elements, and the respective plurality of confidence values.

19. The system of claim 18, wherein the plurality of first refined position data elements comprises a timestamp, corresponding to the geographical location of the first computing device in that iteration, and wherein the first client computing device is configured to calculate the summary refined position data element further based on the plurality of timestamps.

20. A method of determining a geographical location of a client computing device by at least one processor, the method comprising:
receiving, from at least one client computing device, at least two position data elements, each comprising measured longitude and latitude values of the client computing device;
based on the position data elements, determining a direction of motion of the client computing device;
based on the position data elements, calculating a minimal traversal distance between the client computing device and a reference point, wherein the reference point is attributed ground-truth longitude and latitude values;
based on the minimal traversal distance, producing a reference-specific calibration vector, pertaining to the reference point, and representing a required correction of location in a direction substantially perpendicular to the direction of motion; and
applying the reference-specific calibration vector on an instant position data element, to obtain a calibration position data element, representing corrected geographical location of the client computing device.

21. The method of claim 20, wherein applying the reference-specific calibration vector comprises transmitting a plurality of reference-specific calibration vectors, each pertaining to a unique reference point, to the client computing device, and wherein the client computing device is configured to:
calculate an aggregate calibration vector based on the plurality of reference-specific calibration vectors; and
apply the aggregate calibration vector on measured values of longitude and latitude of the instant position data element, to obtain a calibrated position data element, comprising corrected values of longitude and latitude.

22. A method of determining, by at least one processor of a server computing device, a geographical location of one or more client computing devices, the method comprising:
receiving at least one grouping data element, representing a cluster of one or more client computing devices;
obtaining, from at least one client computing device of the one or more client computing devices, at least one respective position data element, representing a geographical location of at least one client computing device; and
calculating a refined position data element representing a determined location of the cluster of one or more client computing devices, based on at least one of: one or more position data elements, and one or more grouping data elements.

23. (canceled)
